(19) United States
(12) Patent Application Publication
(10) Pub. No.: US 2002/0175136 A1
(43) Pub. Date: Nov. 28, 2002

(54) Plastic over-molded bottle

(76) Inventors: Herve F. Bouix, New York, NY (US); Christophe Jacob, Saint Pierre d' Autils (FR)

Correspondence Address: KENYON & KENYON, ONE BROADWAY, NEW YORK, NY, 10004, US

(21) Appl. No.: 09/863,845

(22) Filed: May 23, 2001

(51) Int. Cl. B65D 23/08; B65D 23/02; A47J 41/02

(52) U.S. Cl. 215/12.2; 215/12.1

(57) ABSTRACT

A thick-walled cosmetic container is made by over-molding a resin body on a thin-walled glass or metal bottle. The bottle has a storage portion defining a relatively precisely dimensioned and positioned product storage chamber. A neck extends from the storage portion of the bottle to an open distal end. To over-mold the resin walls on the bottle, the storage portion of the bottle is positioned in a mold cavity dimensioned to define the external shape of the resin walls. The dies forming the mold cavity are adapted to allow at least the distal end of the neck to protrude from the mold while forming a tight seal about the neck. Resin is injected into the mold cavity at a pressure sufficiently low enough to avoid breaking or collapsing the bottle. The resin is cured sufficiently to remove the container from the mold cavity.

### BACKGROUND OF THE INVENTION

1. Field of the Invention

The present invention relates to a thin-walled glass or metal bottle with plastic over-molded on the container portion of the bottle, and a method for making the same. In particular, the invention relates to a cosmetic package wherein a thin-walled bottle made of glass or metal has plastic over-molded on the container portion of the bottle to significantly change the overall shape and appearance of the underlying bottle, thereby increasing the esthetic appeal and durability of the underlying bottle.

2. Description of the Prior Art

Thick-walled containers, particularly those made of transparent or semi-transparent materials, are highly desirable as consumer oriented packaging in certain industries, e.g., the cosmetics, fragrances and personal care products industries. This is because thick-walled containers have a high degree of esthetic appeal and are perceived to be of higher quality than other containers. Thus, thick-walled containers are desirable for packages for products such as, for example, nail polish, mascara, perfume, etc. Thick-walled containers for consumer packaging are typically made from glass or a resin, and may also be made from metal, e.g., aluminum. Of these materials, glass is preferred for many applications because it is perceived to be a higher quality material. This perception is most likely due to the hard, gem-like appearance that glass presents, and, because in transparent or semi-transparent applications, it has a high degree of clarity. In addition, glass is compatible with most products and solvents typically used in consumer products. However, glass has several disadvantages. Glass is substantially heavier than resin materials, adding to shipping and handling costs of products contained in glass packages. Glass packages are also known to be substantially more fragile than resin packages. Glass may break or chip leaving sharp edges that could cut or injure a user. Also, due to the quantity of material required and the greater production efforts and difficulties of molding thick-walled glass containers, the cost is substantially higher than that of comparable containers made from other materials such as, for example, resin.

For reasons similar to those associated with glass, i.e., higher weight, greater cost for raw material, processing, handling and manufacturing, greater difficulty in manufacturing, less precision in mass production, etc., thick-walled metal containers are less frequently used for consumer goods.

Thick-walled containers made from resin are lighter, more durable and safer for consumer packaging (i.e., less likely than glass to break or chip and cause injury). Resin containers are also less expensive both in materials cost and production cost than thick-walled glass or metal containers. In addition, resin can generally be molded to more precise external tolerances. Disadvantageously, resins may not be compatible with certain components or solvents contained in cosmetic or fragrance products. If a resin is incompatible with a contained product, problems may arise such as, for example, contamination of the product, or discoloration of the resin. Thus, the advantages of resin over glass or metal may be significantly negated by compatibility problems.

Thick-walled containers made of either glass, metal or resin suffer at least one common disadvantage. The dimensions, position and shape of the product storage chamber within the thick-walled container may be difficult to predetermine and control during the manufacture of the container. The position and shape of the storage chamber may be important to the esthetic appearance of the container if the container is transparent and a product having a contrasting color is added to the container. Ideally, the storage chamber should be shaped and positioned to provide the best possible esthetic appearance, i.e., centered and properly shaped. Thus, the position and shape of the storage chamber should be readily pre-determinable or predictable, and reproducible during mass production. More importantly, the position and shape of the storage chamber are critical in determining a minimum thickness in the container walls, e.g., if the storage chamber is misshapen or off center, one or more walls of the container may be unnecessarily thin. Accordingly, storage chambers that are consistently and uniformly shaped and positioned within the container are desirable. The dimensions of the storage chamber are important because they determine the storage capacity of the container, which should also be substantially consistent and uniform from container to container. Product storage chambers can be formed with relative precision in thick walled containers if the chamber has a sectional shape or diameter equal to or less than that of the passage through the neck of the container by positioning a suitably dimensioned mandrel in a mold for the container. However, product storage chambers that have a sectional shape or diameter greater than the diameter of the passage through the neck of the container are substantially more difficult to form with any degree of precision without great effort on the part of the manufacturer. The degree of care and effort required adds substantially to the cost of the container. Despite the best efforts of the manufacturer, the known techniques yield thick walled containers having storage chambers with dimensions, shapes and positions that may vary significantly from container to container in mass production.

Accordingly, there is a need for a thick-walled container that offers the esthetic and compatibility advantages of, for example, a glass container, and the cost and production advantages of a resin container. Particularly, there is a need for a thick-walled container that can be mass produced to offer the foregoing advantages together with a product storage chamber that is consistent and accurate in shape, dimension and position within the container.

### BRIEF SUMMARY OF THE INVENTION

In accordance with the present invention, the problems and disadvantages of the containers discussed above are overcome, and a thick-walled container is made by over-molding a substantially solid body of resin material on a thin-walled glass or metal bottle. The glass or metal bottle can be made by known techniques such that a storage portion of the bottle has relatively thin walls defining a precisely dimensioned product storage chamber. A neck extends from the storage portion of the bottle to define an open distal end. Alternatively, a thin-walled glass or metal bottle with a storage portion and a neck can be selected from one of numerous commercially available bottles. To add the thick resin walls to the container, the storage portion of the thin-walled bottle is positioned in a mold cavity dimensioned to define the external shape of the body formed by the resin walls. The dies forming the mold cavity are adapted to allow at least the distal end of the neck of the thin-walled bottle to protrude from the mold. The dies are further adapted to form a tight seal about an outer surface of the bottle, preferably about the neck of the bottle, to define the upper limits of the resin walls. Resin is injected into the mold cavity at a pressure sufficiently low enough to avoid breaking or collapsing the thin-walled bottle. The resin is sufficiently cured to enable removal of the completed container from the mold cavity. The resulting thick resin walls give the container the appearance of a solid, thick-walled container at a substantially lower cost than solid glass or metal, and in a construction that is lighter and more durable than solid glass or metal. The composite container has a glass or metal neck and a precisely dimensioned glass or metal storage chamber which is highly compatible with most products and solvents found in consumer products.

### BRIEF DESCRIPTION OF THE DRAWINGS

FIG. 1 is a sectional view of the container;

FIG. 2 is a perspective view of the bottle;

FIG. 3 is a perspective view of the container;

FIG. 4 is a sectional view of the container in the mold cavity;

FIG. 5 is a sectional view of an alternative embodiment of the invention with two thin-walled bottles taken along sectional line 5-5 in FIG. 6;

FIG. 6 is a sectional view of an alternative embodiment of the invention with two thin-walled bottles shown in FIG. 5;

FIG. 7 is a sectional view of another alternative embodiment of the invention with clearances in the resin body; and

FIG. 8 is an sectional view of another alternative embodiment of the invention with more than one thin-walled bottle embedded in the resin.

### DETAILED DESCRIPTION OF THE INVENTION

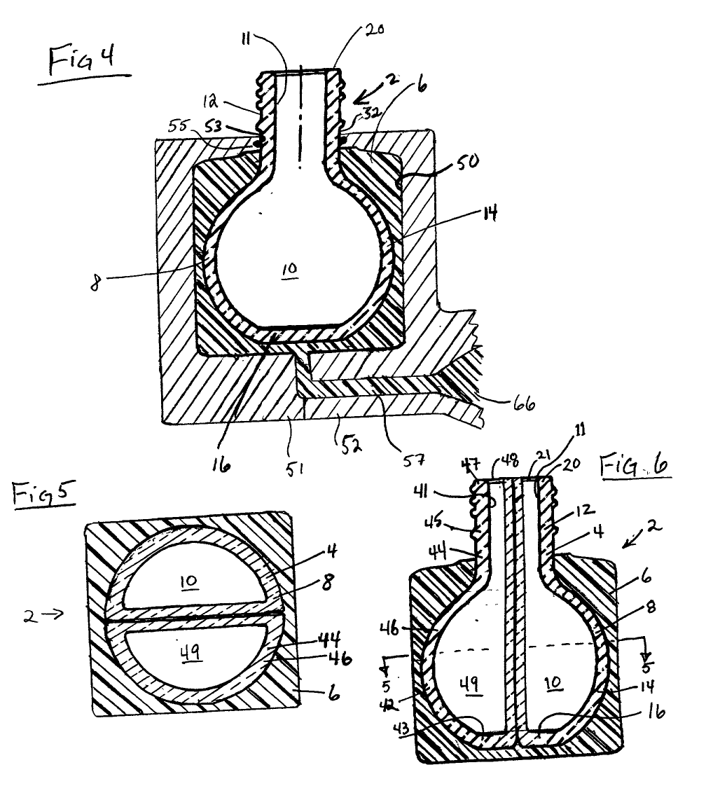

Referring now to FIGS. 1 and 3, a thick-walled composite container according to the invention is shown generally at 2. The composite container 2 consists of a relatively thin-walled glass or metal bottle 4 (FIGS. 1-3) encased in a resin body 6 (FIGS. 1 and 3). The bottle 4 has a storage portion 8 defining a storage chamber 10. A neck 12 extends from the storage portion 8 to a distal end 20 defining an opening 21. The storage chamber 10 is in fluid communication with the opening 21 by way of a passage 11 through the neck 12. The storage portion 8 has a peripheral wall 14 and may have a bottom wall 16, at least one of which has a minimum wall thickness, as indicated, for example, between arrows 18.

The thin-walled bottle 4 can be made from glass or metal (e.g., aluminum) by bottle forming techniques well known in the container industry, e.g., blow molding, rotational casting, compression blow molding, stamping and forming, etc. The bottle 4 is made such that walls 14, 16 define a relatively precisely shaped and dimensioned product storage chamber 10. Alternatively, the bottle 4 can be selected from one of numerous commercially available bottles, such as, for example, bottles made by manufacturers like St. Gobain, Pochet, Wheaton, Borrion, etc. The distal end 20 of the neck 12 may be provided with threads 15 or other suitable means for attaching a closure or a dispenser (not shown) to regulate the flow of product through the opening 21.

The resin body 6 is over-molded about the thin-walled bottle 4 such that at least the opening 21 in the distal end 20 of the neck 12 is exposed. The resin body 6 has a maximum wall thickness dimension, indicated, for example, between arrows 24, which is equal to or greater than the minimum thickness dimension of the walls of the storage portion 8 of the bottle 4. Preferably, the maximum wall thickness of the resin body 6 is at least three times the minimum wall thickness of the storage portion 8. It will be understood that this construction permits the walls of the glass or metal bottle 4 to be reduced to a minimum, thus reducing the quantity of the more costly and heavier material (i.e., glass or metal) required to achieve the thick-walled composite container 2. Because the resin body 6 adds substantial structural strength to the composite container 2, the thickness of the walls of bottle 4 may be reduced to a thickness less than that normally associated with such a container. The walls 14 and 16 of the bottle 4 need only be thick enough to withstand the over-molding process (discussed in greater detail below). Once cured, the resin body 6 protects the relatively thin walls of the storage portion 8 of the bottle 4. On the other hand, because the material forming the resin body 6 is less expensive, lighter and more durable (less subject to breakage, cracking, chipping or denting) than glass or metal, the thickness of the resin body 6 can be maximized to achieve the desired external shape of the thick-walled composite container.

Preferably, at least one of the bottle 4 and the resin body 6 is transparent or semi-transparent. For example, when the resin body 6 is translucent or light impervious, and the bottle 4 is a transparent glass, the portions of the bottle 4 that are exposed by the resin body 6 will provide at least a minimal opportunity to view the contents of the package. When the resin body 6 is transparent or clear and the bottle 4 is translucent or light impervious (e.g., colored glass, coated glass, or metal), the shape and position of the bottle 4 within the resin body 6 become integral esthetic design elements of the overall appearance of the container 2. And, when both the resin body 6 and the bottle 4 are semi-transparent, transparent or clear, the contents of the storage chamber 10 may contrast with the thin walls of bottle 4 and/or the thick composite walls of the container to become a key esthetic element in the overall appearance of the container. Clearly, by varying the degree of transparency and/or the color of a bottle 4 made from glass and the resin body 6, and by matching or contrasting with the color of the product stored in the chamber 10, an infinite variety of appealing combinations can be yielded. Thus, this composite construction can yield an attractive container which has the look and feel of a more expensive container, but is lighter, less costly, more precisely dimensioned and more durable than a fully glass container. In addition, the composite container is significantly more esthetically variable than a container made solely of glass, metal or resin.

A further advantage of the composite construction is that, even when the storage chamber 10 is empty, the shape (e.g., round) of the storage portion 8 of the bottle 4 is clearly visible within the shape (e.g., square) of the resin body 6 when the resin body 6 is semi-transparent or transparent. Thus, the encapsulated portion of the bottle 4 is an important esthetic design element of the container that contributes substantially to the appearance of the container 2. This is the case even when the bottle 4 is made from glass because resins and glass generally have substantially different refractive indices. The difference in refractive indices between resins and glass causes the thickness of the walls 14, 16 of the storage portion 8 to be clearly visible through the resin, appearing to outline the shape of the storage chamber 10 (see FIG. 3).

From a marketing standpoint, this composite arrangement yields a very unique and attractive container. From a quality control and manufacturing standpoint, the composite container 2 is highly desirable because the underlying bottle 4 can be precisely formed to specific dimensions by well known techniques at a low cost, and can be precisely positioned in a relatively thick resin body 6. Thus, the thick-walled composite container 2 can be accurately and cost effectively reproduced with a precisely shaped and positioned storage chamber 10.

In the preferred embodiment shown, for example, the storage portion 8 of the bottle 4 is substantially round or globe-shaped and the resin body 6 is substantially square or cube-shaped. Because the bottle 4 can be precisely formed to specific dimensions by well known techniques in an infinite variety of shapes, it will be understood that the storage chamber may be formed in an infinite variety of shapes, e.g., square, rectangular, triangular, elliptical, star-shaped, hour-glass-shaped, etc. In addition, since the bottle is encased and supported in the resin body 6, the bottle does not require a flat bottom, allowing even greater design options with respect to the bottle shape. Similarly, the resin body 6 can be formed in an infinite variety of shapes by changing the mold cavity in which it is formed, or by working the resin body after it has cured, e.g., by machining, grinding, cutting, etc. Either of the resin body or the bottle can be provided with molded, ground or cut patterns on their respective outer surfaces prior or during over-molding to further enhance the esthetic appearance of the finished container. Thus, variations in the shape of the bottle 4 and the resin body 6 in different combinations will yield an infinite variety of esthetic design possibilities.

Preferably, the resin body 6 substantially encapsulates the bottle 4, except for the protruding distal end 20 of the neck 12. Also contemplated are clearances 75 in the resin body 6 that expose portions of surface 32 of the peripheral wall 14 or bottom wall 16 of the bottle 4. The clearances 75 provide unique design elements in the surface of the composite container 2, and may serve as ports or windows for better viewing of the contents of the container or design elements or indicia 33 on the outer surface 32 of the bottle 4. The clearances 75 are formed by portions (not shown) of the mold dies that occupy a correspondingly shaped space in the mold cavity before resin is injected. These mold portions may also serve to precisely position the bottle 4 within the mold cavity during the molding process.

Prior to over-molding, the outer surface 32 of the bottle 4 may be worked (e.g., grinding, sand-blasting, etching, cutting, etc.), coated (e.g., paint, powder coating, etc.) or otherwise treated to achieve esthetic effects that enhance the appearance of the container subsequent to over-molding. For example, the surface 32 may be textured by grinding or etching processes. Or the surface 32 may be coated in whole or in part with paint or powder coating to color the surface or provide other effects. For example, the paint or coating may contain glass, mica or metal flakes for a shimmer or sparkle effect. Similar processes may be used to apply colors in a pattern. To provide a mirror finish on a glass bottle 4, a metallic coating may be applied. A metal bottle may be highly polished to provide the mirror finish.

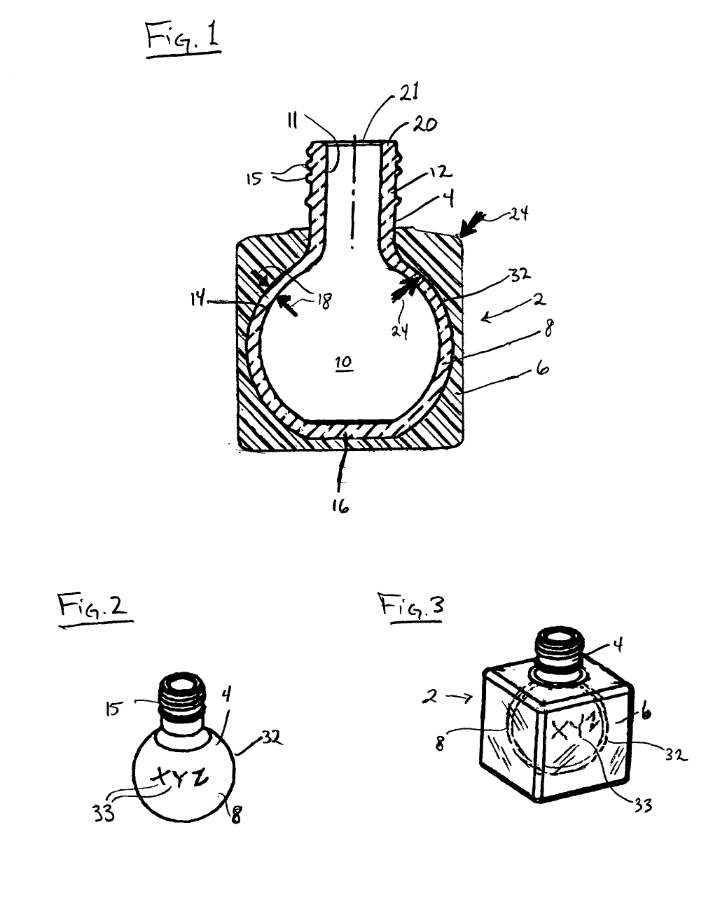

Indicia 33 (FIGS. 2 and 3) may be provided to the container 2 on, for example, the outer surface 32 of the peripheral wall 14 of the bottle 4. The indicia 33 may be in the form of opaque characters or designs adhered to the surface 32, e.g., paint or transfer material. Alternatively, the indicia may be characters or designs provided to the surface 32 in relief or in raised form by, for example, molding, etching, grinding, cutting, etc. When the resin body 6 is transparent, indicia 33 placed on an outer surface 32 of the bottle 4 will clearly be visible through the transparent material comprising resin body 6. It will be understood that, in order to have indicia 33 on surface 32 of the bottle 4 of the finished composite container 2, the indicia 33 must be provided to the surface 32 before the resin body 6 is over-molded on the bottle 4. It will also be understood that indicia can be similarly provided to an outer surface of the resin body 6 by known techniques either during molding or after the resin body has cured.

In any case, treatments (coatings, paints, labels, transfer materials, etc.) applied to the surface 32 before over-molding of the resin body 6 must be adapted to withstand without negative effects the conditions of the over-molding process. In other words, with respect to the preferred embodiment, the surface treatments must be able to withstand heat encountered during the over-molding process, in particular, temperatures in a range of 120-160° C.

Preferably, the resin body 6 is made from a suitable molding resin, e.g., Surlyn®, a registered trademark of and available from DuPont, Wilmington, Del., U.S.A. The use of other suitable thermoplastic or thermoset resins is also contemplated, e.g. olefin, polyurethane, polyethylene, polystyrene, etc, in any form, e.g., elastomer, foam, etc. The selected resin is injected by conventional over-molding techniques into a mold cavity 50 in which the bottle 4 has been inserted and positioned.

As noted above, color and opacity of the resin body 6 and the bottle 4, if it is glass, can be selected to enhance the esthetic appeal and overall appearance of the container. To this end, “sparkle” or “glitter” flakes can be added to the resin in its molten state.

In the case where the bottle 4 is metal, the storage chamber 10 and passage 11 may be treated to further increase its compatibility with various consumer products. For example, if the bottle 4 is made from aluminum, the surfaces of the storage chamber 10 and passage 11 may be anodized so that these surfaces are compatible with a greater variety of products.

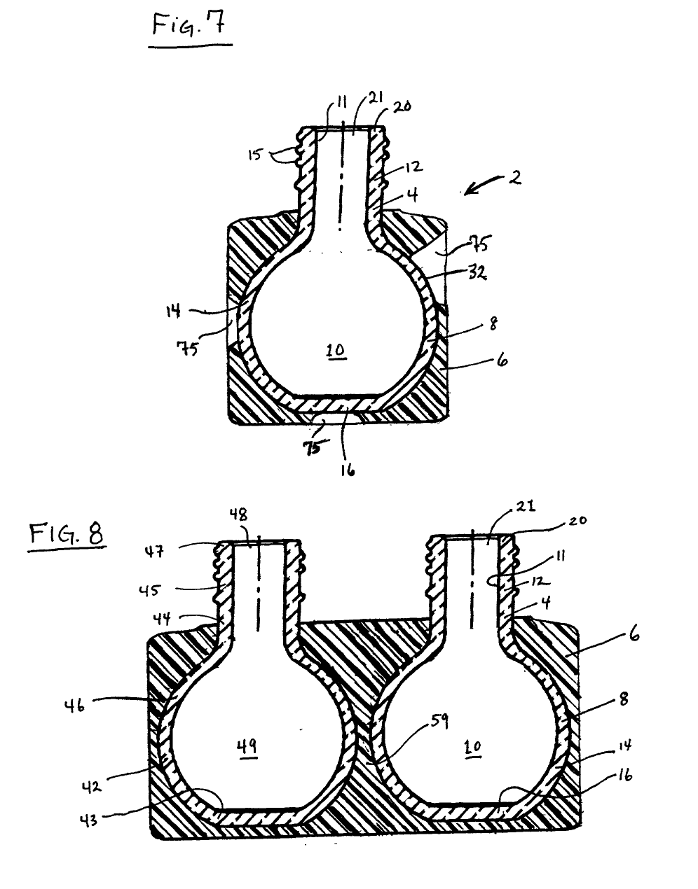

In an alternative embodiment shown in FIGS. 5 and 6, the thick-walled container 2 is provided with a first bottle 4 having the same elements described above, and a second bottle 44. A neck 45 of the second bottle 44 extends from a storage portion 46 to a distal end 47 having an opening 48. The storage portion 46 defines a storage chamber 49 in fluid communication with a passage 41 through the neck 45 to the opening 48. The storage chamber has a peripheral wall 42 and a bottom wall 43, at least one of which has a minimum wall thickness. In this alternative embodiment, the composite container 2 is formed by positioning the storage portions 8, 46 of each bottle 4, 44 in the mold cavity and injecting resin into the cavity. Thus, the resin body 6 is simultaneously over-molded about the first bottle 4 and the second bottle 44 such that at least the distal end 20, 47 of the neck 12, 45 of each bottle 4, 44 protrudes from the resin body 6. By using two or more bottles encapsulated in a resin body, a composite container can be made with two or more storage chambers. The two or more bottles, i.e., 4 and 44, may be arranged and adapted as shown with the necks 12, 45 in close, adjacent position such that a single closure or dispenser (not shown) may be used on both necks (see FIGS. 5, 6). Alternatively, the necks 12, 45 may be in a spaced apart relationship (see FIG. 8), such that each requires a separate closure or dispenser (not shown). Similarly, the storage portions 8, 46 of the bottles 4, 44 may be in a close, adjacent relationship within the resin body 6 (FIGS. 5, 6), or may be in a spaced apart relationship (FIG. 8) within the resin body 6. In a spaced apart relationship, a portion 59 of the resin body 6 would separate parts of the two bottles 4, 44.

Referring now to FIG. 4, the method of making the thick-walled container 2 comprises the steps of providing at least one thin-walled glass or metal bottle 4, positioning at least part of the bottle 4 in a mold cavity 50, and injecting resin 66 into the mold cavity 50 at a pressure sufficiently low to avoid breaking or collapsing the bottle 4. The bottle 4 has a neck 12 extending from a storage portion 8 to a distal end 20. An opening 21 is provided in the distal end 20 of the neck 12. The storage portion 8 defines a storage chamber 10 in fluid communication with a passage 11 through the neck 12 to the opening 21. The storage chamber 10 is defined by a peripheral wall 14 and a bottom wall 16, at least one of which has a minimum wall thickness.

The mold cavity 50 is defined by at least two opposing dies 51, 52. The bottle 4 is positioned in the mold cavity 50 such that at least the distal end 20 of the neck 12 protrudes from the mold cavity 50 through an aperture 53 defined between the opposing dies 51, 52. The aperture 53 is adapted and dimensioned to seal the mold cavity 50 against a corresponding portion of the outer surface 32 of the bottle 4, preferably about the neck 12. The sealing of the aperture 53 against the outer surface 32 of a bottle 4 is accomplished by dimensioning the aperture 53 to fit precisely about the surface 32. Alternatively, and to allow for manufacturing tolerances, the aperture 53 is dimensioned to fit closely about the surface 32, and at least one elastomer gasket or O-ring 55 is provided to fill the gap between the perimeter of the aperture 53 and the surface 32 of the bottle 4. The gasket or O-ring 55 is preferably made from a synthetic or natural rubber elastomer having a high durometer (e.g., 80 Shore A) and a high resistance to damage from heat.

After the bottle 4 has been positioned properly within the mold cavity 50, and the aperture 53 is sealed against the outer surface 32 of the bottle 4, resin 66 is injected into the mold cavity 50 in an over-molding process, e.g., resin transfer molding. Alternatively, the mold cavity 50 may be filled with a casting resin in a casting process. The resin may be injected, for example, through a port 57. The resin 66 is injected into the mold cavity 50 at a temperature suitable to keep it fluid, and at a pressure sufficiently low to avoid breaking or collapsing the bottle 4. The bottle 4 and/or mold dies 51, 52 may be preheated or cooled if it is deemed necessary for receiving a particular resin. After the mold cavity has been adequately filled with fluid resin, the resin 66 in the mold cavity 50 is allowed to cure sufficiently to permit removal of the completed composite container 2 from the mold cavity 50. Curing of the resin may be facilitated, for example, by heating or cooling the dies and/or bottle, as required by the selected resin.

The resulting composite container 2 is a thick-walled container that offers the esthetic and product compatibility advantages of a glass or metal container combined with the cost, durability and production advantages of a resin container. In addition to these advantages, the thick-walled composite container 2 can be consistently and accurately mass produced with a product storage chamber having a pre-determined shape, volume and position within the container. The appearance of the composite container 2 can also be enhanced in ways previously not practical, e.g., clearances in the resin body 6, color contrasts between the bottle 4 and the resin body 6, indicia 33 on the surface 32 of the bottle 4 that are visible through the resin body 6, etc. The construction of the composite container 2 thus facilitates cost effective production of thick-walled containers with technical and esthetic advantages over known thick-walled containers.

While the invention has been described and illustrated as embodied in preferred forms of construction, it will be understood that various modifications may be made in the structure and arrangement of the parts without departing from the spirit and the scope of the invention recited in the following claims.

What is claimed is:

1. A thick-walled container comprising:
a first thin-walled bottle with a neck extending from a storage portion to a distal end having an opening, the storage portion defining a storage chamber in fluid communication with a passage through the neck to the opening, the storage chamber having a peripheral wall and a bottom wall at least one of which has a minimum wall thickness; and
a resin body over-molded about the first bottle such that at least the distal end of the neck protrudes from the resin body, the resin body having a maximum wall thickness at least three times greater than the minimum wall thickness of the storage portion.

2. The thick-walled container of claim 1 wherein the bottle is made from one of metal or glass.

3. The thick-walled container of claim 2 wherein the metal is aluminum.

4. The thick-walled container of claim 1 wherein at least one of the bottle and the resin body is transparent.

5. The thick-walled container of claim 1 wherein the resin body is transparent and the storage portion of the bottle is substantially round.

6. The thick-walled container of claim 5 wherein the resin body is square.

7. The thick-walled container of claim 1 wherein the resin body substantially encapsulates the bottle except for the protruding distal end of the neck.

8. The thick-walled container of claim 1 wherein the resin body is transparent and at least a portion of an outer surface of the bottle beneath the resin body is provided with a treatment in the form of one of grinding, etching, cutting, a coating, a label and a transfer.

9. The thick-walled container of claim 8 wherein the treatment further comprises indicia.

10. The thick-walled container of claim 1 wherein the resin body is made from Surlyn.

11. The thick-walled container of claim 1 wherein the resin body further comprises at least one clearance exposing part of an outer surface of the bottle.

12. The thick-walled container of claim 3 wherein at least the passage and the storage chamber are anodized.

13. The thick-walled container of claim 1 further comprising a second bottle with a neck extending from a storage portion to a distal end having an opening, wherein the resin body is over-molded about the second bottle such that at least the distal end of the neck of the second bottle protrudes from the resin body.

14. A method of making a thick-walled container comprising the steps of:
providing at least one thin-walled bottle, the bottle having a neck extending from a storage portion to a distal end having an opening, the storage portion defining a storage chamber in fluid communication with a passage through the neck to the opening, the storage chamber having a peripheral wall and a bottom wall at least one of which has a minimum wall thickness;
positioning the bottle in a mold cavity defined by opposing dies, the bottle positioned in the mold cavity such that at least the distal end of the neck protrudes from the mold cavity through an aperture defined between the opposing dies, the aperture adapted and dimensioned to seal the opposing dies against a corresponding surface of the bottle;
injecting resin into the mold cavity at a pressure sufficiently low to avoid breaking or collapsing the bottle; and
curing the resin sufficiently to remove the thick-walled container from the mold cavity.

15. The method of claim 14 wherein the bottle is made from one of glass or metal.

16. The method of claim 15 wherein the metal is aluminum.

17. The method of claim 14 further comprising an elastomer gasket in the aperture to seal the opposing dies against the corresponding surface of the bottle.
